(19) United States
(12) Patent Application Publication
(10) Pub. No.: US 2005/0131755 A1
(43) Pub. Date: Jun. 16, 2005

(54) Sales rolling forecast managing system and method and recording medium

(75) Inventors: Tiros Chen, Shindian City (TW); Mavis Liao, Shindian City (TW); Irving Fan, Shindian City (TW); Richard Lai, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/990,468

(22) Filed: Nov. 18, 2004

(30) Foreign Application Priority Data
Dec. 12, 2003 (TW) 092135320

(51) Int. Cl. G06F 17/60

(52) U.S. Cl. 705/10

(57) ABSTRACT

A sales forecast managing system comprises a forecast receiving module, a forecast database, a forecast analyzing module, and an outputting module. At least one user inputs sales forecast information through the forecast receiving module. The sales forecast information comprises numerous sales forecasts for numerous periods and numerous products respectively. The forecast database records the input sales forecast information and storages at least one history sales forecast information, which comprises numerous history sales forecasts for periods and products. The periods of the history sales forecast information and the periods of the sales forecast information are partially overlapped. The forecast analyzing module analyses the sales forecast information and the history sales forecast information, and the outputting module outputs the analyzing result of the forecast analyzing module. Furthermore, a sales forecast managing method and a recording medium, having a computer executable program for performing the method, are provided.

### BACKGROUND OF THE INVENTION

1. Field of Invention

The invention relates to a sales forecast managing system and method and, in particular, to a sales rolling forecast managing system and method capable of managing sales forecasts dynamically according to history information.

2. Related Art

Generally speaking, a business unit often hires many sales persons to handle various kinds of sales and customer service activities. The relevant information of these activities is not only important to the sales departments, but also important to other departments, such as the warehouse managing department and accounting department.

Since it costs a lot of time to purchase and/or to manufacture products, the sales persons must put forecasts on the needs of various products for a certain period of time, so that they can have sufficient products in the future. If the production period of a product is four weeks, at the first week a sales person may forecast the demand of this product for the sixth week, which is called a sales forecast. To effectively control the relationships between the product stocks and the actual sales amount, a sales person would re-evaluate the sixth-week forecast every week. In a conventional sales forecast system, if the re-evaluated sales forecast is different from the previous one, the latter forecast would replace the previous one since the sales forecast would be more accurate when it is more close to the actual sales period (the sixth week).

However, the conventional sales forecast system (such as a general commercialized enterprise resource planning (ERP) system) simply replaces the sales forecast of the sales person, and cannot provide relevant information to the whole business unit or trace how the relevant information changes with time. When the organization of the business unit is complex, the market varies quickly, the preparation time of relevant departments is long, there exists several sales persons responsible for the same product, or several different products need to be processed at the same time, the conventional sales forecast system cannot integrate different messages effectively and provide forecasts systemically.

Therefore, it is a strong need for a sales forecast managing system and method that can integrate different messages effectively and provide forecasts systemically.

### SUMMARY OF THE INVENTION

In view of the above subjective, the invention is to provide a sales forecast managing system and method that can integrate information effectively and provide forecasts systemically.

To achieve the above, the sales forecast managing system of the invention comprises a forecast receiving module, a forecast database, a forecast analyzing module, and an outputting module. The forecast receiving module receives at least one sales forecast information (usually input by the user), and the sales forecast information comprises a sales forecast of at least one product within at least one period. The forecast database stores the sales forecast information and at least one history sales forecast information. The history sales forecast information comprises a history sales forecast of the product within a plurality of periods, and the period of the history sales forecast information is partially overlapped with the period of the sales forecast information. The forecast analyzing module analyzes the sales forecast information and the history sales forecast information. The outputting module outputs the analysis result of the forecast analyzing module.

The invention also discloses a sales forecast managing method, which comprises the steps of: receiving the sales forecast information, analyzing the sales forecast information and at least one history sales forecast information, and outputting the analysis result of the sales forecast information and the history sales forecast information. The sales forecast information comprises a sales forecast of at least one product within at least one period, and the history sales forecast information comprises a history sales forecast of the product within a plurality of periods. The period of the history sales forecast information is partially overlapped with the period of the sales forecast information.

The invention further provides a recording medium, which records a computer readable sales forecast managing program. The sales forecast managing program is for the computer to perform the above-mentioned sales forecast managing method of the invention.

Since the sales forecast managing system and method of the invention keep the history sales forecast information, and analyze the sales forecast information and the history sales forecast information together, the sales forecasts can be integrated and provided effectively and systemically. More particularly, one can handle the variation history of the forecasts and adjust the forecasts based on the information at hand, which make it easier to effectively provide relevant information to the whole business unit, to trace the variation of the information, and to analyze the reason of the variation.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram showing the sales forecast managing system according to an embodiment of the invention;

FIG. 2 is a schematic diagram showing a plurality of sales forecast information and actual sales amounts stored in a forecast database;

FIGS. 3A to 3C are schematic diagrams illustrating the analysis results of a forecast analyzing module according to the embodiment of the invention;

FIG. 4 is a schematic diagram showing the analysis results of the forecast analyzing module and the correction results of a forecast amount correction module; and

FIG. 5 is a flowchart showing the steps of the sales forecast managing method according to the embodiment of the invention.

### DETAILED DESCRIPTION OF THE INVENTION

The sales forecast managing system and method according to the embodiments of the invention will be described below with reference to relevant drawings, wherein the same elements are referred with the same reference numbers.

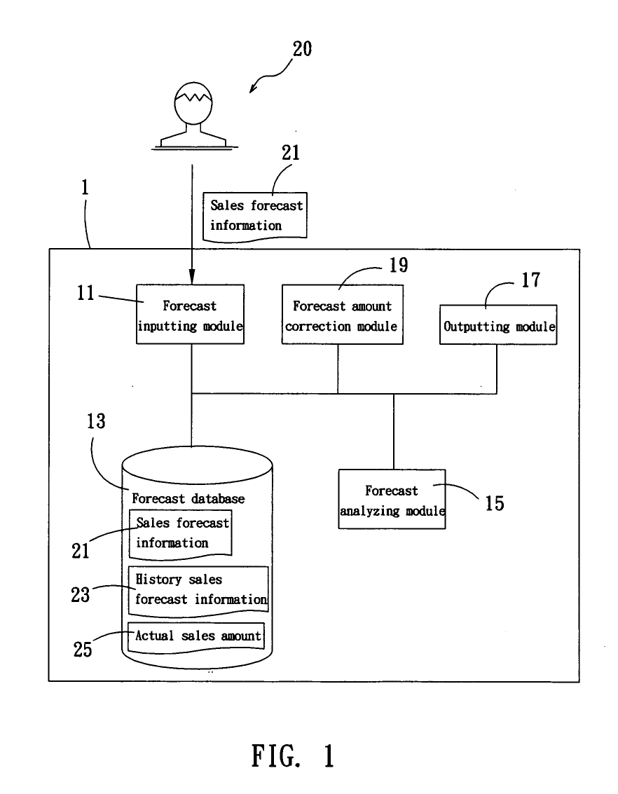

Please refer to FIG. 1, the sales forecast managing system 1 according to an embodiment of the invention comprises a forecast receiving module 11, a forecast database 13, a forecast analyzing module 15, and an outputting module 17. In this embodiment, the forecast receiving module 11 receives sales forecast information 21 from at least one user 20. The sales forecast information 21 comprises a sales forecast of at least one product within at least one period. The forecast database 13 stores the sales forecast information 21 and at least one history sales forecast information 23 that comprises the history sales forecast of the product within several periods. The periods of the history sales forecast information 23 and the period of the sales forecast information 21 are partially overlapped. The forecast analyzing module 15 analyzes the sales forecast information 21 and the history sales forecast information 23. The outputting module 17 outputs the analysis result of the forecast analyzing module 15.

It should be noted that the sales forecast managing system 1 could be implemented in an electronic apparatus, such as a conventional computer that comprises a central processing unit (CPU), a storage device, an input device and an output device. The CPU could be in any conventional architecture, such as including an arithmetic logic unit (ALU), a register and a controller, for performing various kinds of operations and to control the operations of other devices in the electronic apparatus. The storage device could be anyone or the combination of computer-readable data storage devices, such as a hard disc drive, an optical disc drive, a dynamic random access memory (DRAM), an electrically erasable programmable read-only memory (EEPROM), or the combinations thereof. The input device could be any device that allows a user to input data or instructions to the electronic apparatus, such as a keyboard or a mouse. The output device could be a display device that can display the analysis result of the forecast analyzing module 15.

The modules of the present embodiment could be software modules stored in the storage device. The CPU accesses the software modules, and realizes the functions of the modules through the devices in the electronic apparatus, such as the input device, the storage device, the output device or other software modules. However, it should be noted that persons having ordinary skill in the art may design firmware or hardware, such as an application-specific integrated circuit (ASIC), to realize the function of the software modules mentioned above without departing from the spirit and the scope of the invention. Furthermore, the forecast database 13 could be any computer-accessible database, such as an electronic database stored in the storage device mentioned above.

In the present embodiment, the history sales forecast information 23 is the sales forecast information received (such as input by the user) before one period and/or several periods, and may be the information of one or more products (depending on the job of the sale person inputting the information). The forecast analyzing module 15 may analyze the sales forecast information 21 and the history sales forecast information 23 of the same user input in different periods to effectively analyze whether the sales forecast of a particular user is accurate. The forecast analyzing module 15 may also analyze the sales forecast information 21 and the history sales forecast information 23 of different sources (such as difference users) to effectively integrate the sales forecasts and stock amount of the whole business unit. Since the information could be processed using the user or the product as the variable, the forecast analyzing module 15 may process the sale forecast of one product or multiple products.

When the time moves to the period previously forecasted, an actual sales amount 25 of this period is obtained. This actual sales amount 25 is then received and stored in the forecast database 13. At this time, since the forecast period of the history sales forecast information 23 is at least partially overlapped with the period of the sales forecast information 21, the forecast analyzing module 15 further analyzes the sales forecast information 21, the history sales forecast information 23 and the actual sales amount 25 to further compare the deviations between the sales forecasts and the actual sales amounts of the same source (such as the same salesman), different sources (such as different users), the same product and different products. Based on the above, the sales forecast managing system 1 might further comprise a forecast correction module 19 that corrects the sales forecast in the sales forecast information 21 based on the sales forecast information 21, the history sales forecast information, and the actual sales amount 25. Moreover, the corrected sales forecast information 21 might be output by an outputting module 17.

One feature of the present embodiment is the rolling process. On one hand, any specific old information is obtained by gradually approaching from the recorded information of multiple old periods, so that relevant departments can have enough time to process and prepare step by step. On the other hand, for any period, forecast information of certain future periods may be input and corrected gradually for the reference of relevant departments.

To make the invention more comprehensive, an example of the operation procedure of the sales forecast managing system 1 according to the embodiment of the invention will be described hereinbelow.

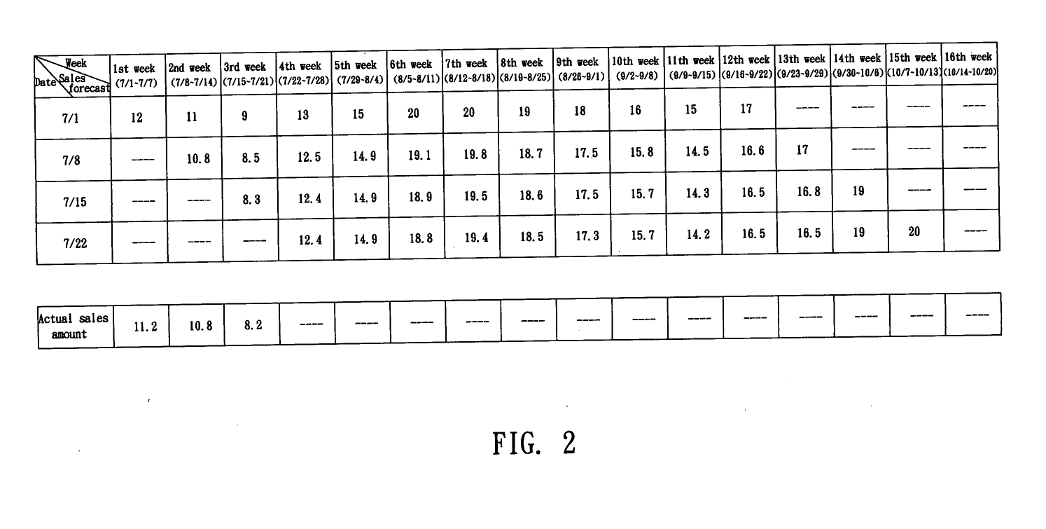

First, the sales forecast information input by the user is received via the forecast receiving module 11, and each sales forecast information comprises a series of sales forecast. Please refer to FIG. 2, in the present embodiment, the user inputs the sales forecast information one time a week, and each sales forecast information forecasts the sales amounts of the twelve weeks in the future. For example, at the beginning of the first week (July 1), the user forecasts the weekly sales forecast of the coming twelve weeks (July 1˜September 22). At the beginning of the second week (July 8), the user forecasts the weekly sales forecast of the coming twelve weeks (July 8˜September 29). At the beginning of the third week (July 15), the user forecasts the weekly sales forecast of the coming twelve weeks (July 15˜October 6). At the beginning of the fourth week (July 22), the user forecasts the weekly sales forecast of the coming twelve weeks (July 22˜October 13). In the present embodiment, the product is a driver IC, and the unit of the sales forecast shown in FIG. 2 is ten thousands. Moreover, since the current date is July 22, the sales forecast information the user input (the weekly forecast from July 22 to October 13) is the sales forecast information 21 mentioned previously, and the sales forecast information previously input (the weekly forecasts input on July 1, July 8 and July 15) are the history sales forecast information 23 previously mentioned. These sales forecast information, including the sales forecast information 21 and the history sales forecast information 23, are stored in the forecast database 13.

The forecast database 13 further stores the actual sales amount 25 of each week. As shown in FIG. 2, since the current date is July 22, the forecast database 13 will store the actual sales amounts from the first week to the third week. The actual sales amounts of the subsequent weeks have not been generated.

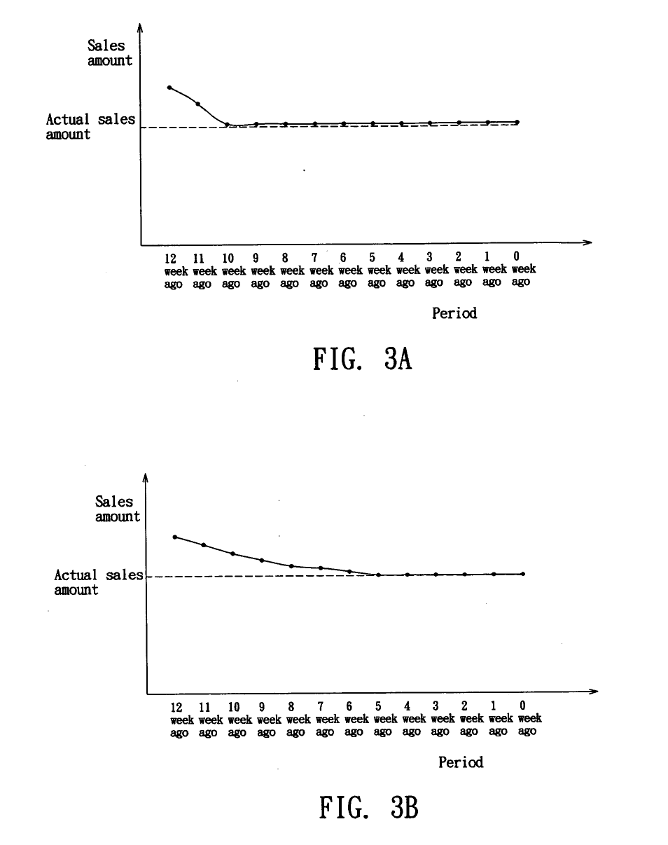

The forecast analyzing module 15 analyzes the forecast accuracy of this user or other necessary analysis results based on the sales forecast information stored in the forecast database 13 (as shown in FIG. 2). Please refer to FIG. 3A, for a specific period, if the forecast sales amounts previously input by this user approach the actual sales amount quickly (for example, the third sales forecast is very close to the actual sales amount), it can be determined that this user is good at predicting the market needs. Therefore, when this analysis result is shown to the warehouse managing department via the outputting module 17, the warehouse managing department can rely on the sales forecast information of this user and prepare the stocks of the coming weeks in advance.

Moreover, as shown in FIG. 3B, for a specific period, if the forecast sales amounts previously input by this user approach the actual sales amount slowly (for example, the sales forecast is close to the actual sales amount at the eighth input), it can be determined that this user may be capable of predicting of the market needs, but the capability of putting sales forecast is not good enough. Therefore, when this analysis result is shown to the warehouse managing department via the outputting module 17, the warehouse managing department should be cautious when preparing the stocks of the coming weeks to avoid the excess or insufficient amount of the stocks.

As shown in FIG. 3C, for a specific period, if the forecast sales amounts previously input by this user are completely deviated from the actual sales amount, it can be determined that this user is not capable of predicting of the market needs. When this analysis result is shown to the warehouse managing department via the outputting module 17, the warehouse managing department should ignore and abandon the sales forecast information from this user, or make corrections to the sales forecast information.

From the above, the forecast sales amounts previously input by this user are completely deviated from the actual sales amount, the forecast amount correction module 19 corrects the subsequent sales forecast in the sales forecast information based on the previous sales forecast information and the actual sales amount of each period. For example, if the user forgets to input the demand amount of a specific customer, the sales forecast information may be lower than the actual sales amount every week. When this happens, the forecast amount correction module 19 corrects the sales forecast information of this user, and may obtain a good forecast result (as shown in FIG. 3C).

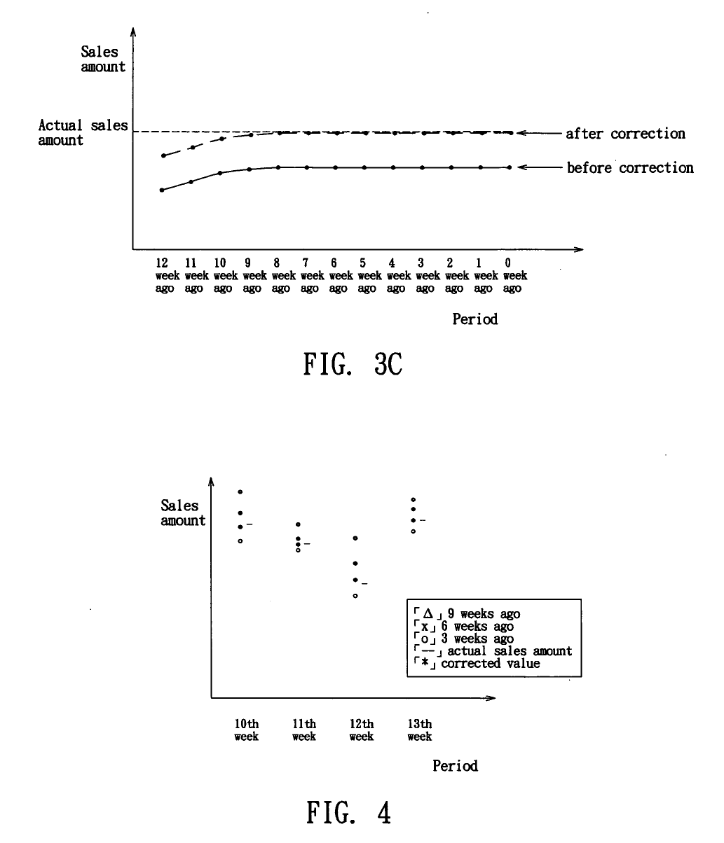

It should be noted that the sales forecast managing system 1 may analyze the sales forecast information input by a plurality of users in a plurality of periods integrally to provide sales forecast results systematically. In the present embodiment, the forecast database 13 stores the sales forecast information input by a plurality of users, which is as shown in FIG. 2. The forecast analyzing module 15 can integrate all the sales forecast information, and can output the analysis result to, for example, the warehouse managing department, through the outputting module. Referring to FIG. 4, which shows the analysis result of the sales forecast information of the 10^{th} to 13^{th} weeks. The sales forecast information input nine weeks before each period is denoted by “Δ”, the sales forecast information input six weeks before each period is denoted by “x”, the sales forecast information input three weeks before each period is denoted by “o”, and the actual sales amount of each period is denoted by “—”. The error of the overall sales forecast information can be obtained from FIG. 4, and the error can be corrected, for example, using the average of the sales forecast information of the previous three weeks and the sales forecast information of the previous six weeks. This corrected value is denoted by “*”.

Moreover, if multiple data are input in one period, which means that information of the same item is input several times, the system of the present embodiment can store the history records. That is, on the one hand the information last input can be used to be the sales forecast information of this period, and on the other hand the other input information can be stored as the reference of subsequent operations such as the correction of the sales forecast information.

It is apparent that the system of the present embodiment can focus on the forecast of a single product or multiple products. The detailed descriptions are omitted here for concise purpose.

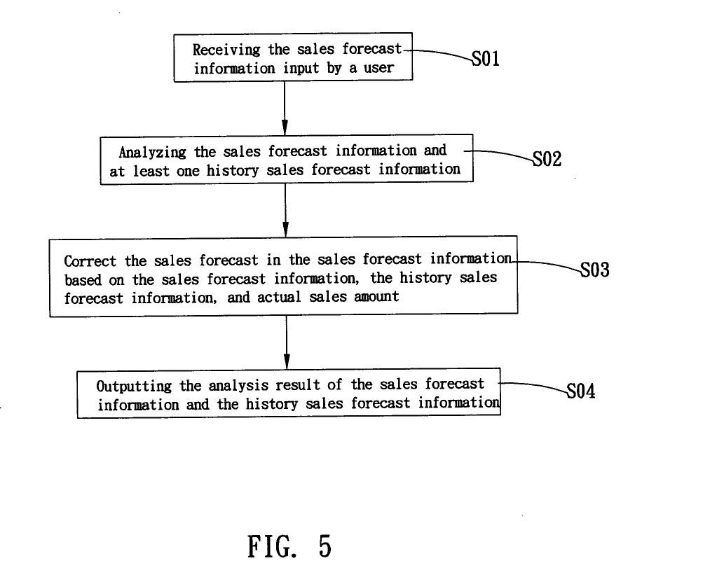

The invention also discloses a sales forecast managing method, which manages the sales forecasts using the sales forecast managing system 1 mentioned above. Referring to FIG. 5, the method comprises the steps of: receiving the sales forecast information input by a user (S01), analyzing the sales forecast information and at least one history sales forecast information (S02), and outputting the analysis result of the sales forecast information and the history sales forecast information (S04). Furthermore, the method may correct the sales forecast in the sales forecast information based on the sales forecast information, the history sales forecast information, and actual sales amount (S03). Since the method according to the embodiment of the invention can be realized by the sales forecast managing system 1 mentioned previously, the detailed descriptions of its steps are omitted for concise purpose.

Since the invention can be implemented by software modules, a storage medium (such as a compact disc, a floppy disc, or a swappable hard disc drive) can be used to record a sales forecast managing program comprising these software modules. Thus, a computer may access the storage medium to execute the sales forecast managing program, so as to carry out the sales forecast managing method mentioned above. The sales forecast managing program comprises a plurality of program segments, which correspond to the functions mentioned in the above embodiments.

To sum up, since the sales forecast managing system and method of the invention keep the history sales forecast information, and analyze the sales forecast information and the history sales forecast information, sales forecast information can be integrated and provided effectively and systemically. Therefore, the whole business unit can receive more effective information, and trace how the sales forecasts change with time. Moreover, the sales forecast managing system and method of the invention can correct the forecast result dynamically to manage the sales forecasts more effectively.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A sales forecast managing system, comprising:
a forecast receiving module for receiving at least one sales forecast information, the sales forecast information comprising a sales forecast of at least one product within at least one period;
a forecast database for storing the sales forecast information and at least one history sales forecast information, the history sales forecast information comprising history sales forecasts of the product within a plurality of periods, and the period of the history sales forecast information being partially overlapped with the period of the sales forecast information;
a forecast analyzing module for analyzing the sales forecast information and the history sales forecast information; and
an outputting module for outputting the analysis result of the forecast analyzing module.

2. The sales forecast managing system according to claim 1, wherein the history sales forecast information comprises at least one sales forecast information input by the user in a previous period.

3. The sales forecast managing system according to claim 1, wherein the forecast analyzing module analyzes the sales forecast information and the history sales forecast information of the same user and/or a plurality of users.

4. The sales forecast managing system according to claim 1, wherein the forecast analyzing module analyzes the sales forecast information and the history sales forecast information of the same product and/or a plurality of products.

5. The sales forecast managing system according to claim 1, wherein the forecast database further stores at least one actual sales amount, and the forecast analyzing module further analyzes the sales forecast information, the history sales forecast information, and the actual sales amount.

6. The sales forecast managing system according to claim 1, wherein when information of an item within one period is input several times, the forecast database uses the last input information as the sales forecast information of the period, and stores the other input information for reference of subsequent operations.

7. The sales forecast managing system according to claim 5, further comprising:
a forecast correction module for correcting the sales forecast information based on the sales forecast information, the history sales forecast information, and the actual sales amount.

8. The sales forecast managing system according to claim 7, wherein the outputting module further outputs the corrected sales forecast information.

9. A sales forecast managing method, comprising:
receiving at least one sales forecast information, the sales forecast information comprising a sales forecast of at least one product within at least one period;
analyzing the sales forecast information and at least one history sales forecast information, the history sales forecast information comprising history sales forecasts of the product within a plurality of periods, and the period of the history sales forecast information being partially overlapped with the period of the sales forecast information; and
outputting the analysis result of the sales forecast information and the history sales forecast information.

10. The sales forecast managing method according to claim 9, wherein the history sales forecast information is another sales forecast information input in a previous period.

11. The sales forecast managing method according to claim 9, wherein the step of analyzing the sales forecast information and the history sales forecast information comprising:
analyzing the sales forecast information and the history sales forecast information of the same user; and
analyzing the sales forecast information and the history sales forecast information of a plurality of users.

12. The sales forecast managing method according to claim 9, wherein the step of analyzing the sales forecast information and the history sales forecast information comprising:
analyzing the sales forecast information and the history sales forecast information of the same product; and
analyzing the sales forecast information and the history sales forecast information of a plurality of products.

13. The sales forecast managing method according to claim 9, further comprising:
correcting the sales forecast information based on the sales forecast information, the history sales forecast information, and the actual sales amount and to output the corrected sales forecast information.

14. The sales forecast managing method according to claim 9, wherein when information of an item within one period is input several times, the method further comprises:
using the last input information as the sales forecast information of the period; and
storing the other input information for reference of subsequent operations.

15. A recording medium, which records a computer readable sales forecast managing program, the program comprising:
a forecast inputting program segment for the computer to receive at least one sales forecast information input by a user, the sales forecast information comprising a sales forecast of at least one product within at least one period;
a forecast analyzing program segment for the computer to analyze the sales forecast information and at least one history sales forecast information, the history sales forecast information comprising history sales forecasts of the product within a plurality of periods, and the period of the history sales forecast information being partially overlapped with the period of the sales forecast information; and
an outputting program segment for the computer to outputting the analysis result of the sales forecast information and the history sales forecast information.

16. The recording medium according to claim 15, wherein the history sales forecast information is another sales forecast information input by the user in a previous period.

17. The recording medium according to claim 15, wherein the forecast analyzing program segment is for the computer to perform at least one of the following steps:
analyzing the sales forecast information and the history sales forecast information of the same user;
analyzing the sales forecast information and the history sales forecast information of a plurality of users;
analyzing the sales forecast information and the history sales forecast information of the same product; and
analyzing the sales forecast information and the history sales forecast information of a plurality of products.

18. The recording medium according to claim 15, wherein the forecast analyzing program segment is for the computer to analyze the sales forecast information, the history sales forecast information, and at least one actual sales amount.

19. The recording medium according to claim 15, wherein the program further comprises:
a forecast correction program segment for the computer to correct the sales forecast information based on the sales forecast information, the history sales forecast information, and at least one actual sales amount.

20. The recording medium according to claim 15, wherein when information of an item within one period is input repeatedly, the program is further for the computer to perform the steps of:
using the last input information as the sales forecast information of the period; and
storing the other input information for reference of subsequent operations.
